(19) United States
(12) Patent Application Publication
(10) Pub. No.: US 2014/0150339 A1
(43) Pub. Date: Jun. 5, 2014

(54) HIGH YIELD BAMBOO PLANTATION

(71) Applicant: Kimberly-Clark Worlwide. Inc., Neenah, WI (US)

(72) Inventors: Richard Louis Underhill, Neenah, WI (US); Thomas Gerard Shannon, Neenah, WI (US); Geoffrey Fenn Calow, Neenah, WI (US)

(73) Assignee: Kimberly-Clark Worlwide. Inc., Neenah, WI (US)

(21) Appl. No.: 14/084,963

(22) Filed: Nov. 20, 2013

Related U.S. Application Data
(60) Provisional application No. 61/731,662, filed on Nov. 30, 2012.

(51) Int. Cl. A01C 21/00

(52) U.S. Cl. CPC A01C 21/00
USPC 47/58.1 R; 800/298

(57) ABSTRACT

The present invention provides high yield mixed species bamboo plantations and methods for planting the same. The invention comprises a method of planting two or more bamboo species in alternating rows or in other configurations. In some embodiments, the present invention provides a plantation comprising two or more bamboo species that are substantially uniform in regards to height, circumference and density at maturity are well suited for use in pulp and paper applications.

### BACKGROUND

Bamboo is the common term for members of a particular taxonomic group of large woody grasses (subfamily Bambusoideae, family Andropogoneae/Poaceae). Bamboos encompass about 1250 species within 75 genera, most of which are relatively fast-growing, attaining stand maturity within five years. In many areas bamboo occurs as natural forests, but is being depleted due to overexploitation and poor management. This issue needs to be addressed through plantation-based cultivation.

Perhaps the greatest challenge to developing plantation-based cultivation of bamboo is the fact that many commercially important bamboos only flower at intervals of as long as 60-130 years. Compounding the difficulties of this long flowering cycle is the fact that many bamboos exhibit mass (or gregarious) flowering, with all plants in the population flowering simultaneously. For example, Phyllostachys bambusoides flower at an interval of 130 years, and in this species all plants of the same stock flower at the same time, regardless of differences in geographic locations or climatic conditions. After flowering, the bamboo dies.

Bamboo's lengthy flowering interval and propensity for mass flowering makes it very difficult to obtain seeds for propagation. Compounding this problem is the fact that bamboo seeds, even when they are available, remain viable for no more than 3-6 months.

As a result of these difficulties with the propagation of bamboo by seed, bamboo typically is propagated by asexual techniques such as clump division and cutting. These asexual propagation techniques, however, are insufficient to meet projected world demand because both their capacity to produce mass scale production, and their practical efficiency, are too low.

### SUMMARY

It has now been surprisingly discovered that the yield of a bamboo plantation, and more specifically a bamboo plantation planted with bamboo plantlets that have been propagated by micropropagation, may be increased by planting two or more varieties of bamboo within a single plantation. By planting two or more varieties of bamboo, such as a Phyllostachys Moso variety and a Phyllostachys nigra henon variety, for example, the overall yield per acre of plantation may be increased relative to a plantation planted with only a single species of bamboo. In this manner the yield per acre may be increased by at least about 10 percent, such as from about 10 to about 50 percent. The increase in yield is particularly great when two or more varieties of bamboo are planted at similar planting densities and in a pattern such that each bamboo is adjacent to a species of bamboo that is different than itself.

Accordingly, in one embodiment the present invention provides a bamboo plantation comprising an intercropped first and second bamboo, wherein the first bamboo is planted at least at a density of at about 50 plantlets per acre and the second bamboo is planted at a density of at least about 50 plantlets per acre.

In other embodiments the present invention provides a plantation comprising two or more first varieties of bamboo planted in a spaced apart relation thereby defining an inter-row space and at least one second species of bamboo planted within the inter-row space.

In still other embodiments the present invention provides a plantation comprising at least a first and a second row of a first species of bamboo plantlets, the first and second rows defining an inter-row space there-between, wherein intra-row spacing of the first species of bamboo plantlets is less than about 3 meters and an intercropped second species of bamboo planted within the inter-row area.

In another embodiment the present invention provides a method of planting a bamboo plantation comprising the steps of planting a first species of bamboo in a first row;

and planting a second species of bamboo in a second row, wherein the first and second rows are spaced apart from one another from about 0.5 to about 6 meters.

In yet another embodiment the present invention provides a method of planting a bamboo plantation comprising the steps of planting two or more first varieties of bamboo planted in a spaced apart relation thereby defining an inter-row space and planting least one second species of bamboo planted within the inter-row space.

Other features and aspects of the present invention are discussed in greater detail below.

### DESCRIPTION OF THE DRAWINGS

FIG. 1 illustrates a bamboo plantation according to one embodiment of the present invention; and

FIG. 2 illustrates a bamboo plantation according to another embodiment of the present invention.

### DETAILED DESCRIPTION

The present invention provides high yield mixed species bamboo plantations and methods for planting the same. The invention comprises a method of planting two or more bamboo species in alternating rows or in other configurations. In some embodiments, the present invention provides a plantation comprising two or more bamboo species that are substantially uniform in regards to height, circumference and density at maturity are well suited for use in pulp and paper applications. For example, in one embodiment a bamboo plantation comprises intercropped first and second bamboo varieties, wherein the first bamboo species is selected from Phyllostachys Moso and planted at a density of at least about 50 plantlets per acre and the second bamboo species is selected from Phyllostachys nigra henon and planted at a density of at least about 50 plantlets per acre.

In other embodiments, the bamboo plantation is planted so as to yield high amounts of uniform bamboo biomass material, which may be used in pulp and paper applications by intercropping two or more bamboo clones, two or more bamboo varieties, two or more bamboo species or two or more bamboo genus.

In some embodiments, the particular bamboo genus is selected from the group consisting of Acidosasa sp., Ampleocalamus sp., Arundinaria sp., Bambusa sp., Bashania sp., Borinda sp., Brachystachyum sp., Cephalostachyum sp., Chimonobambusa sp., Chusquea sp., Dendrocalamus sp., Dinochloa sp., Drepanostachyum sp., Eremitis sp., Fargesia sp., Gaoligongshania sp., Gelidocalamus sp., Gigantocloa sp., Guadua sp., Hibanobambusa sp., Himalayacalamus sp., Indocalamus sp., Indosasa sp., Lithachne sp., Melocanna sp., Menstruocalamus sp., Nastus sp., Neohouzeaua sp., Neomicrocalamus sp., Ochlandra sp., Oligostachyum sp., Olmeca sp., Otatea sp., Oxytenanthera sp., Phyllostachys sp., Pleioblastus sp., Pseudosasa sp., Raddia sp., Rhipidocladum sp., Sasa sp., Sasaella sp., Sasamorpha sp., Schizostachyum sp., Semiarundinaria sp., Shibatea sp., Sinobambusa sp., Thamnocalamus sp., Thyrsostachys sp., Yushania sp. and mixtures thereof.

In still other embodiments, the bamboo plantation comprises two or more bamboo species selected from the group consisting of Phyllostachys Moso, Phyllostachys bissetti; Phyllostachys nigra henon; Fargesia denudata; Pleioblastus fortunei; Sasa Veitchii; Pleioblastus viridistriatus; Thamnocalamus crassinodus; Chusquea Culeo “Cana Prieta”; Bambusa Old Hamii; Phyllostachys Atrovaginata; Dendrocalamus Asper; or Guadua Angustifolia Arundinaria gigantea; Bambusa balcoa; Bambusa vulgaris; Bambusa vulgaris ‘Vitatta’; Bambusa Oldhamii; Bambusa tulda; endrocalamus brandesii; Dendrocalamus aspen; Dendrocalamus hamiltoni; Dendrocalamus giganteus; Dendrocalamus membranaceus; Dendrocalamus strictus; Gigantochloa aspera; Gigantochloa scortechini; Guadua culeata; Guadua aculeata ‘Nicaragua’; Guadua amplexifolia; Guadua angustifolia; Guadua angustofolia bicolor; Guadua paniculata; Melocanna bambusoides; eohouzeaua dullooa (Teinostachyum); Ochlandra travancorica; and Schizostachyum lumampao.

In a particularly preferred embodiment the plantation comprises two different species of temperate bamboos selected from the genus Phyllostachys sp., for example Phyllostachys heterocycla pubescens (also referred to as Phyllostachys Moso herein) and Phyllostachys bambusoides. Or, in alternative embodiments the plantation may comprise Phyllostachys Moso and Phyllostachys nigra henon.

In some embodiments, the bamboo plants used to plant the bamboo plantation are grown in a natural environment, grown in a cultivated area, and/or grown in a growth facility (e.g., a greenhouse).

In some embodiments, the bamboo plants are propagated by natural pollination. For example, such bamboo plants are obtained from bamboo seeds.

In other embodiments, the bamboo plants are propagated by conventional macropropagation methods, such as vegetative propagation. Non-limiting examples of vegetative propagation include clump division (e.g., offsets planting and rhizome planting), whole culm cutting, layering, culm-segment cutting, branch cutting and macroproliferation. In some embodiments, the pure bamboo plant is propagated by micropropagation, such as tissue culturing.

In a particularly preferred embodiment, each bamboo variety comprises a single bamboo clone, variety, species, or genus. For example, the bamboo plantation may comprise bamboo plantlets derived from the germplasm of a specific Phyllostachys Moso clone and plantlets derived from the germplasm of a specific Phyllostachys nigra henon clone. In some embodiments, both the Phyllostachys Moso clone and Phyllostachys nigra henon clone are derived from micropropagation methods.

Regardless of the method of producing bamboo plantlets, the plantlets are preferably planted at a density of at least about 100 plantlets per acre. The initial planting density depends upon site conditions and the size of the species involved. Generally, higher densities are suitable for the establishment of small-sized bamboos such as Bambusa Old Hamii, while large-size bamboos such as Phyllostachys Moso may be planted at lower densities. However, the planting density should not be so low as to result in canopy exposure, low soil moisture and strong competition from weeds. Conversely, overstocking at planting will also result in low productivity due to the intense competition among the plantlets for light, space, soil moisture and nutrients. Accordingly, planting densities of at least about 100 plantlets per acre, such as from about 100 to about 500 plantlets and more preferably from about 150 to about 300 plantlets per acre are desirable.

In those instances where the bamboo plantation comprises two different bamboo varieties, it is preferred that the total plantlet density is at least about 100 plantlets per acre, such as from about 100 to about 200 plantlets per acre, however the different bamboo varieties may be planted at the same or different densities. For example, the plantation may have a total plantlet density of about 200 plantlets per acre and comprise a first and second bamboo species, where the first bamboo species is planted at a density from about 50 to about 100 plantlets per acre and the second bamboo species is planted at a density from about 100 to about 150 plantlets per acre.

Where plantations comprise two or more different bamboo varieties, the two or more different bamboo varieties are preferably planted such that each first species of bamboo is adjacent to a second species of bamboo. In this manner the two or more different bamboo varieties are “intercropped,” which is used herein to define the planting arrangement where two or more different bamboo varieties are grown in proximity to one another. A variety of different planting patterns are envisioned to achieve intercropping.

For example, in one embodiment two bamboo varieties may be intercropped by planting in alternating rows, at the same or different densities. In this manner, each bamboo species is planted with individual plantlets defining a line, referred to herein as a “row line”. These row lines are often, but not necessarily, straight lines, and are preferably generally parallel to one another.

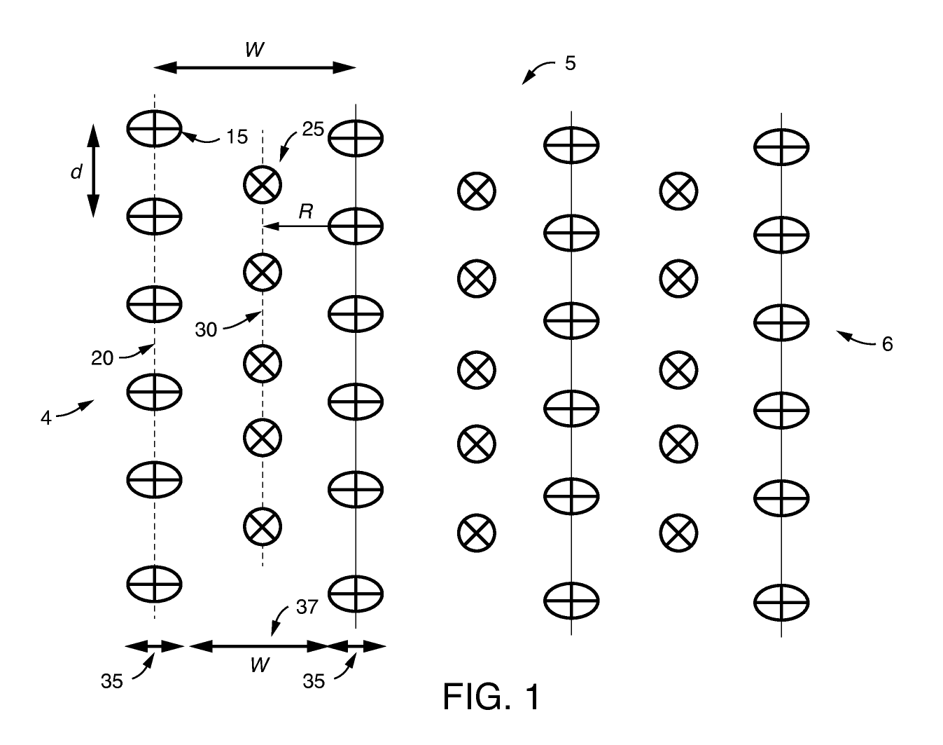

For purposes of discussion of the present invention, it is helpful to define particular areas or zones within a plantation. The bamboo species are generally intended to be planted in “rows,” which is referred to herein as a plurality of bamboo plantlets from the same species planted adjacent to one another in a line, and more preferably in a straight line. With reference to FIG. 1, first 15 and second 25 bamboo species are planted in rows 20, 30. The illustrated bamboo plantation 5 comprises four rows 20 of a first species of bamboo 15 and four rows 30 of a second species of bamboo 25. The first varieties of bamboo 15 define the lateral edges 4, 6 of the plantation 5. The first varieties of bamboo 15 are planted in spaced apart rows 20 separated from one another by a distance W. Depending on planting density, W may vary from about 8 to about 20 meters and in particularly preferred embodiments from about 10 to about 15 meters.

As further illustrated in FIG. 1, a row area 35 surrounds each of the first rows 20. The row area 35 generally extends between generally parallel edges to each side of the row line. For example, the row area 35 may extends at least about 0.25 meters, such as from about 0.25 to about 0.5 meter, to each side of the row line 20, such that the row area 35 has a width from about 0.5 to about 1 meter. The remaining area between adjacent row areas 35 is referred to herein as an “inter-row area.” As illustrated in FIG. 1, the inter-row area 37 generally has a width (w) greater than about 3 meters, such as from about 3 to about 9 meters and in a particularly preferred embodiment from about 5 to about 7 meters. In a preferred embodiment the second species of bamboo is planted in the inter-row area in accordance with the present invention, such that the distance between the first and second rows of bamboo, measured as R, is less than about 8 meters, such as from about 3 to about 7 meters and in particularly preferred embodiments from about 4 to 5 meters.

In a particularly preferred embodiment the rows of similar species are planted about 10 meters apart, the row areas are about 1 meter wide, the spacing between adjacent plantlets is about 5 meters and the inter-row (w) areas are about 8 meters wide. As will be clear to those of skill in the art, the transition between a row area and an inter-row area is not a sharply defined line but is used herein for discussion of where or how particular parts of the inventive method are preferably practiced.

For example, in one embodiment, a first species of bamboo plantlet selected from Phyllostachys Moso is planted in rows at a density of at least about 50 plantlets per acre, and a second species of bamboo plantlet selected from Phyllostachys nigra henon is planted between the rows of the first bamboo species at a density of at least about 50 plantlets per acre. Preferably, the two varieties of bamboo are planted such that each first bamboo plantlet is less than about 6 meters from a second bamboo plantlet and more preferably less than about 5 meters and in and in particularly preferred embodiments from about 3 to 4.5 meters.

In a particularly preferred embodiment high yield bamboo plantation is created by planting alternating rows of two different varieties of bamboo, wherein the first bamboo is Phyllostachys Moso and the second bamboo is Phyllostachys nigra henon. Each row of bamboo may be planted in straight, curved or a mixture of straight and curved lines, according to the geography of the planting area. The rows of Phyllostachys Moso are spaced apart from one another from about 8 to about 12 meters and between the rows of Phyllostachys Moso are planted rows of Phyllostachys nigra henon.

In certain embodiments a fertilizer is applied to the bamboo plantation, either prior to planting, simultaneously with planting, or in other embodiments after planting. In a particularly preferred embodiment a fertilizer comprising phosphorus, potassium and nitrogen is applied and more preferably the fertilizer is applied in amounts sufficient to provide 100:50:50 kilograms per hectare (N:K:P) at the beginning of the growing season.

In some preferred embodiments of the present invention, fertilizer is applied to the row area while not applying any substantial amount of fertilizer to the inter-row area. This allows the fertilizer to be utilized primarily by only one bamboo species. As used herein, “simultaneous” means that the various operations, such as soil preparation, planting, and application of fertilizer and/or herbicide are accomplished within a given inter-row area substantially at the same time, such that less than about twenty-four hours and preferably less than about twelve hours separates the first and last operation.

In other embodiments the present invention provides a method for planting a bamboo plantation comprising the steps of planting of at least two species of bamboo in soil without tilling, but with the simultaneous application of herbicide and fertilizer.

In some embodiments, the invention utilizes strip or zone tillage technology between adjacent rows of a first species of bamboo to prepare plantlet bed between each row. The second bamboo species plantlets are planted in the tilled bed and then the soil is packed over the plantlet to complete planting. At about the same time that the field is subjected to zoned tillage, postemergent herbicide is applied to the field, including the row area and at least part of the inter-row area, for weed control, and a fertilizer application is applied. In a particularly preferred embodiment the fertilizer is applied within about 30 centimeters of inter-row area to maximize effectiveness. This method and timing of combining the three operations (spraying, fertilizing and seeding a cover crop) and performing them in a no-till field provides numerous benefits. For example, it may reduce the cost and energy associated with multiple trips while facilitating these environmentally sound practices. The method also facilitates the establishment of a first bamboo species quickly, deterring the development of competitive vegetation while the second bamboo species becomes established.

Effective establishment of a first species of bamboo could also help reduce the establishment of weed species in the plantation during the winter and early spring and perhaps slow the development of herbicide resistant weeds in some cropping systems.

In a particularly preferred embodiment prior to the planting of the first and second bamboo the soil prepared to a method referred to as tilling. Specifically a soil preparation element, such as a tool having a coulter, is used to cut through the soil to break up the surface of the soil and prepare it for planting. This also at least partially exposes the soil to receive the bamboo plantlet. In some embodiments, the coulter provides a furrow that allows planting of plantlets about 20 centimeters deep in the soil.

After a soil preparation element prepares the plantlet bed the bamboo plantlets may be planted. The first species of bamboo is planted in spaced-apart rows and the second species of bamboo is planted in the inter-row area. The second species of bamboo may be planted in rows similar to the first species of bamboo and may be planted at the same or different density then the first species of bamboo. After the plantlet is sowed a portion of soil is deposited so as to at least partially pack or firm the soil in the inter-row area. This may cover and embed some of the plantlet to increase the root-to-soil contact.

After the second species of bamboo is planted the field may be treated with an herbicide and/or a fertilizer. In a particularly preferred embodiment the herbicide and/or fertilizer is applied to the inter-row area and at least part of the row planted with the first species of bamboo. The herbicide and/or fertilizer may be applied using an applicator having a spray boom and a spray nozzle with a wide spray pattern, and the nozzle may be positioned from about 30 to about 60 centimeters above the ground and preferably below the leaves of the bamboo plant:lets.

In a particularly preferred embodiment the second species of bamboo is planted from about 4 to about 8 weeks after planting after the first species of bamboo. This is the ideal time frame to apply supplemental nitrogen fertilizer since it coincides with the stage of growth when nutrient uptake by the plants is increasing rapidly. This reduces the exposure of the fertilizer to environmental conditions that could cause it to be lost in runoff or leaching events. It is also the optimum time for postemergent herbicide applications to control any weeds that may have escaped from the initial herbicide applications to the crop. Use of the present invention may allow the planter to skip the use of preemergent herbicide at the time of planting of the first bamboo species.

In other embodiments, the first bamboo species is planted in rows in late November or early December. Then, after about 4 to about 8 weeks, an apparatus is used to fertilize the first species of bamboo, prepare the soil in the inter-row area, plant the second species of bamboo, embed the plantlets, and apply herbicide.

While the mixed species bamboo plantation of FIG. 1 illustrates two bamboo species planted in alternating straight line rows to achieve a plantation density of at least about 100 plantlets per acre and more preferably at least about 120 plantlets per acre, such as from about 100 to about 200 plantlets per acre and still more preferably from about 100 to about 150 plantlets per acre. While alternating rows of bamboo varieties are illustrated in FIG. 1 other planting arrangements are contemplated. Generally any planting arrangement that achieves a bamboo plantation having at least two species of bamboo planted at a total density of at least about 100 bamboo plantlets per acre, wherein the two bamboo species are planted at a sufficient density and spacing so as to form an intertwined root system is sufficient. Without being bound by any particular theory, it is believed that for the roots of two different bamboo species to become intertwined the two bamboo species must be planted adjacent to one another and less than about 10 meters apart, such as from about 4 to about 8 meters apart, and more preferably from about 2.5 to about 7 meters apart.

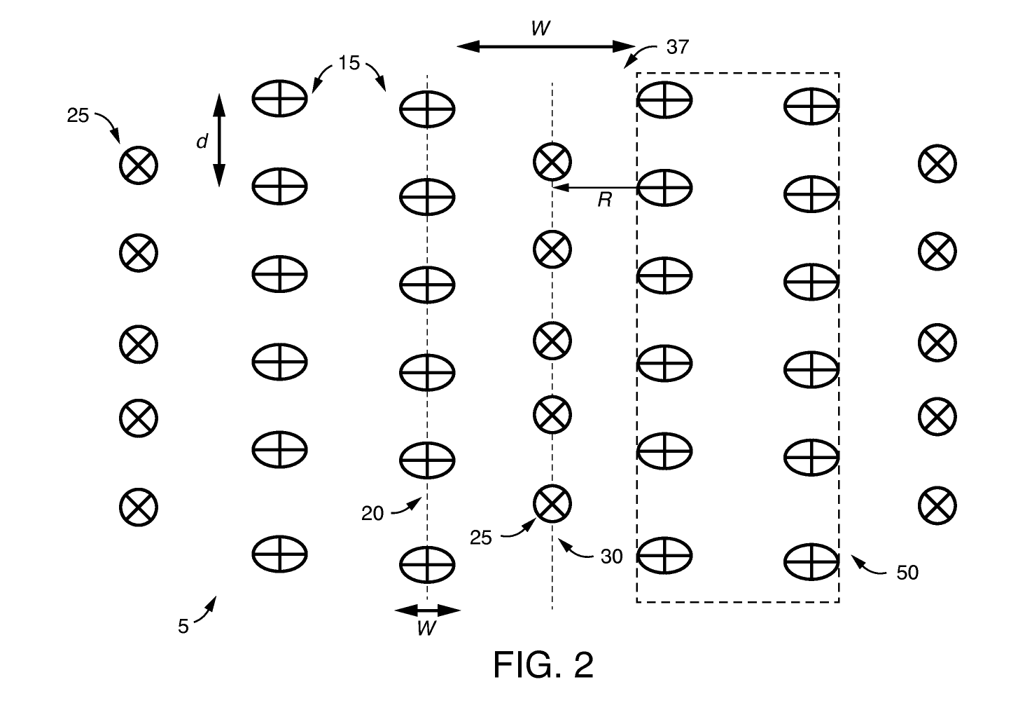

For example, in an alternative embodiment, illustrated in FIG. 2, a first species of bamboo 15 is planted as two adjacent rows 20 to form an area 50 of first species bamboo 15. The area of first species bamboo 50 is repeated throughout the plantation 5 and spaced apart from one another to form inter-row areas 37. The second bamboo species 25 is planted in the inter-row area 37 away from the bamboo area 50, each first bamboo species 20 being adjacent to at least one second bamboo species 30. In this manner the first bamboo species 20 is planted at a higher density than the second bamboo species 30, yet the two species are planted such that their respective root systems may become intertwined and thereby increase the overall yield of the plantation 5.

In a particularly preferred embodiment, the planter sows the bamboo plantlets at about 5 meters apart (illustrated as R in FIG. 1) for each row 20 of first bamboo species 15, resulting in a linear arrangement of first bamboo plantlets 15 and then randomly intercrops a second species of bamboo 25 such that each second bamboo 25 is immediately adjacent to at least one first bamboo species 15.

In certain embodiments the operator plants both first 15 and second 25 bamboo plantlets by hand using a hoedad to deposit the plantlets at a depth from about 20 and 40 centimeters. In a particular preferred embodiment the planter, using a hoedad, continues planting a first species of bamboo plantlet resulting in rows of a first species of bamboo having a row area of about 0.5 meter wide and an inter-row area about 4 meters wide. The second bamboo species plantlets are then planted between two consecutive first bamboo species rows.

In addition to creating an effective root network and leaf canopy, the preferred embodiment produces high yields of bamboo. Typically within about five years from planting the bamboo plantation has reached maturity and may be harvested. Yields of bamboo may vary from about 10 to about 50 dry metric tons per acre per year, such as from about 15 to about 30 dry metric tons per year. The exact yield of bamboo per year may vary depending on the species planted, the planting density and harvesting methodology. However, planting rows of a first bamboo species within at least about two meters of rows of a second species of bamboo increases the overall yield of the plantation compared to a plantation planted with a single species of bamboo by at least 10 percent, such as from about 10 to about 50 percent and more preferably from about 20 to about 30 percent.

In a particularly preferred embodiment bamboo plantations comprising Phyllostachys Moso and Phyllostachys nigra henon intercropped as described herein results in an aboveground net primary productivity greater than about 15 dry metric tons per acre per year less than ten years after planting and more preferably less than six years after planting. For example, a bamboo plantation may be planted with Phyllostachys Moso and Phyllostachys nigra henon plantlets grown from tissue culture. The plantations may be planted at a density of about 200 plantlets per acre and comprise 50% Phyllostachys Moso and 50% Phyllostachys nigra henon planted in alternating rows.

We claim:

1. A bamboo plantation comprising an intercropped first species of bamboo and second species of bamboo, wherein the first bamboo is planted at a density of at least about 50 plantlets per acre and the second bamboo is planted at a density of at least about 50 plantlets per acre, wherein the first and second bamboo species are different.

2. The bamboo plantation of claim 1 wherein the first and second bamboo species are selected from the group consisting of Phyllostachys Moso, Phyllostachys bissetti; Phyllostachys nigra henon; Fargesia denudata; Pleioblastus fortunei; Sasa Veitchii; Pleioblastus viridistriatus; Thamnocalamus crassinodus; Chusquea Culeo “Cana Prieta”; Bambusa Old Hamii; Phyllostachys Atrovaginata; Dendrocalamus Asper; or Guadua Angustifolia Arundinaria gigantea; Bambusa balcoa; Bambusa vulgaris; Bambusa vulgaris ‘Vitatta’; Bambusa Oldhamii; Bambusa tulda; endrocalamus brandesii; Dendrocalamus aspen; Dendrocalamus hamiltoni; Dendrocalamus giganteus; Dendrocalamus membranaceus; Dendrocalamus strictus; Gigantochloa aspera; Gigantochloa scortechini; Guadua culeata; Guadua aculeata ‘Nicaragua’; Guadua amplexifolia; Guadua angustifolia; Guadua angustofolia bicolor; Guadua paniculata; Melocanna bambusoides; eohouzeaua dullooa (Teinostachyum); Ochlandra travancorica; and Schizostachyum lumampao.

3. The bamboo plantation of claim 1 wherein the first bamboo species is Phyllostachys Moso and the second bamboo species is Phyllostachys nigra henon.

4. The bamboo plantation of claim 1 wherein the first bamboo are planted at a density from about 50 to about 100 plantlets per acre and the second bamboo are planted at a density from about 50 to about 100 plantlets per acre.

5. The bamboo plantation of claim 1 wherein the first bamboo and the second bamboo are planted in alternating rows and the inter-row areas ranges from about 7 to about 19 meters.

6. The bamboo plantation of claim 1 wherein no first bamboo species is adjacent to another first bamboo species.

7. The bamboo plantation of claim 1 wherein the first and second bamboo species are produced by micropropagation.

8. The bamboo plantation of claim 1 wherein the total density of first and second bamboo species is from about 100 to about 300 plantlets per acre.

9. A method of planting a bamboo plantation comprising the steps of planting a first bamboo species in a first row; and planting a second bamboo species in a second row, wherein the first and second rows are spaced apart from one another from about 2.5 to about 7 meters.

10. The method of claim 9 further comprising the step of applying at least one treatment agent selected from the group consisting of fertilizer and herbicide prior to planting the first or second species of bamboo.

11. The method of claim 9 further comprising the step of mechanically treating the soil to be planted prior to planting the first or second bamboo species.

12. The method of claim 9 wherein the first bamboo species is Phyllostachys Moso and the second bamboo species is Phyllostachys nigra henon.

13. The method of claim 9 wherein the first and second bamboo species are planted mechanically at least about 10 centimeters below the surface of the soil.

14. The method of claim 9 wherein the first bamboo species are planted at a density from about 50 to about 100 plantlets per acre and the second bamboo species are planted at a density from about 50 to about 100 plantlets per acre.

15. A method of planting a bamboo plantation comprising the steps of planting a first species of bamboo in spaced apart relation to one-another thereby defining an inter-row space and planting a second species of bamboo planted within the inter-row space, whereby no first species of bamboo is adjacent to another first species of bamboo.

16. The method of claim 15 further comprising the step of applying at least one treatment agent selected from the group consisting of fertilizer and herbicide prior to planting the first or second species of bamboo.

17. The method of claim 15 further comprising the step of mechanically treating the soil to be planted prior to planting the first or second species of bamboo.

18. The method of claim 15 wherein the first bamboo species is Phyllostachys Moso and the second bamboo species is Phyllostachys nigra henon.

19. The method of claim 15 wherein the first and second bamboo species are planted mechanically at least about 10 centimeters below the surface of the soil.

20. The method of claim 15 wherein the first species of bamboo are planted at a density from about 50 to about 100 plantlets per acre and the second bamboo species are planted at a density from about 50 to about 100 plantlets per acre.
